(19) United States
(12) Patent Application Publication
(10) Pub. No.: US 2008/0202259 A1
(43) Pub. Date: Aug. 28, 2008

(54) Method For Determining Pesticide Residues in Soil or Plant Material

(75) Inventors: Jane Stewart, Durham, NC (US); Manasi Saha, Apex, NC (US); John E. Jones, Fuquay Varina, NC (US); Adam Finch, Mebane, NC (US); Samy Abdel-Baky, Cary, NC (US)

Correspondence Address: ROTHWELL, FIGG, ERNST & MANBECK, P.C., 1425 K STREET, N.W., SUITE 800, WASHINGTON, DC, 20005, US

(73) Assignee: BASF AKTIENGESELLSCHAFT, Ludwigshafen (DE)

(21) Appl. No.: 11/915,512

(22) PCT Filed: May 24, 2006
(86) PCT No.: PCT/EP2006/004996

§ 371 Date: Nov. 26, 2007

(30) Foreign Application Priority Data
Jun. 7, 2005 (EP) 05012218.3

(51) Int. Cl. G01N 1/00

(52) U.S. Cl. 73/863

(57) ABSTRACT

The present invention relates to a method for determining pesticide residues in the soil or plant material, which comprises processing a soil or plant material sample to a fine powder, converting the powder or a portion thereof into a form accessible for determining the analyte, and determining the analyte. The invention is thus concerned with environmental analysis and in particular environmental trace analysis. The method advantageously allows the use of microextraction techniques and thus a high sample throughput.

The present invention relates to a method for determining pesticide residues in soil or plant material. The invention is thus concerned with environmental analysis and in particular environmental trace analysis.

Pesticides are used in agriculture, forestry, industry and in urban areas. Thousands of tons are applied worldwide each year, usually in admixture with auxiliary agents which make them suitable for application in solid, liquid, or gaseous form, e.g. as sprays, dusting agents and the like. Pesticides arrive, either directly or via crop plants, onto and into the soil or in ground water and surface water.

The use and the toxicity of pesticides is decisively influenced by their behaviour in the environment. They can be, for instance, absorbed, vaporized, leached out, metabolized and/or changed chemically or photochemically. These processes depend on abiotic and biotic factors. Important factors are the physicochemical properties of the pesticides such as solubility, volatility, mobility and degradability. Soil characteristics and boundary conditions are also important.

Therefore, there is a need for screening the environment for pesticidal contamination on a regular basis. Also, such screenings have to be carried out routinely during the development and registration of pesticides in order to elucidate the candidate compound's behaviour in the environment, e.g. for determining half-lifes, DT₅₀, etc. In fact, pesticide manufacturers are required to develop and submit analytical methods for their pesticide products to support the case for registration of their products.

Procedures for determining pesticide residues in environmental samples are usually combinations of various methods and techniques comprising steps such as sampling, sample pre-treatment, e.g. drying, size-reduction, sieving and subdivision, sample preparation, e.g. digestion, extraction, purification, distribution and pre-concentration, measurement and evaluation.

Sampling is recognized as having a central importance in this procedure and therefore the size of the bulk sample is in many cases a mandatory regulatory requirement. Bulk sample sizes of at least 500 to 5,000 grams of soil or plant material are typically needed to statistically represent the residue situation found in the field. Usually, such a bulk sample is then homogenized, for example by grinding and sieving the sample, and 5 to 25 grams of aliquot are subjected to the sample preparation in order to convert it into a form accessible for measurement. However, sample weights ranging from 5 grams to 25 grams can usually be processed in series only and furthermore require relatively large amounts of chemicals for sample preparation. For instance, 100 to 500 mL of solvent are typically needed in order to extract a sample weighing in the range of 5 to 25 grams (see, for instance, “Quality control methods for medicinal plant materials” 1998, World Health Organization, Geneva, ISBN: 92 4 1545100 0; Vania et al., J. Braz. Chem. Soc. Vol. 14, No. 2, 304-309, 2003; Camel, Analusis Magazine, 1998, 26, M99-M111).

All these methods are cumbersome and not suited for high-throughput analysis.

For soil or plant material, it has now been found that processing the bulk sample to a fine powder allows a more efficient performance of a reliable environmental analysis for pesticide residues. Especially the size of the sample aliquot to be converted into a form accessible for measurement can be substantially reduced.

The present invention thus relates to a method for determining a pesticidal analyte in soil or plant material, which comprises processing a soil or plant material sample to a fine powder, converting the powder or a portion thereof into a form accessible for determining the analyte, and determining the analyte.

The method of the present invention has several advantages as compared to conventional residue analysis of soil or plant material such as reduced solvent usage, improved sample throughput, reduction of space allocation in the laboratory and reduced analysis cost.

According to the present invention, the pesticidal analyte can be a pesticide or a transformation product of a pesticide.

The term pesticide is used to mean a large variety of crop controlling agents. A pesticide may be any substance or mixture of substances intended for preventing, destroying, repelling, or mitigating any pest. Pests can be insects, mice and other animals, unwanted plants (weeds), fungi, or microorganisms like bacteria and viruses. Pesticides in particular include avicides, antifeedants, acaricides, bactericides, bird repellents, chemosterilants, defoliants, desiccants, fungicides, herbicides, herbicide safeners, insect aftractants, insecticides, insect repellents, mammal repellents, mating disrupters, molluscicides, nematicides, plant activators, plant growth regulators, rodenticides, synergists, and virucides.

Based on chemical classes, pesticides include in particular acylalanine fungicides, acylamino acid fungicides, aliphatic amide organothiophosphate insecticides, aliphatic nitrogen fungicides, aliphatic organothiophosphate insecticides, amide fungicides, amide herbicides, anilide fungicides, anilide herbicides, antiauxins, antibiotic acaricides, antibiotic fungicides, antibiotic herbicides, antibiotic insecticides, antibiotic nematicides, aromatic acid herbicides, aromatic fungicides, arsenical herbicides, arsenical insecticides, arylalanine herbicides, aryloxyphenoxypropionic herbicides, auxins, avermectin acaricides, avermectin insecticides, benzamide fungicides, benzanilide fungicides, benzimidazole fungicides, benzimidazole precursor fungicides, benzimidazolylcarbamate fungicides, benzofuranyl alkylsulfonate herbicides, benzofuranyl methylcarbamate insecticides, benzoic acid herbicides, benzothiazole fungicides, benzothiopyran organothiophosphate insecticides, benzotriazine organothiophosphate insecticides, benzoylcyclohexanedione herbicides, bipyridylium herbicides, botanical insecticides, botanical rodenticides, bridged diphenyl acaricides, bridged diphenyl fungicides, carbamate acaricides, carbamate fungicides, carbamate herbicides, carbamate insecticides, carbamate nematicides, carbanilate fungicides, carbanilate herbicides, chitin synthesis inhibitors, chloroacetanilide herbicides, chloronicotinyl insecticides, chloropyridine herbicides, chlorotriazine herbicides, conazole fungicides, copper fungicides, coumarin rodenticides, cyclic dithiocarbamate fungicides, cyclodiene insecticides, cyclohexene oxime herbicides, cyclopropylisoxazole herbicides, cytokinins, defoliants, diacylhydrazine insecticides, dicarboximide fungicides, dicarboximide herbicides, dichlorophenyl dicarboximide fungicides, dimethylcarbamate insecticides, dinitroaniline herbicides, dinitrophenol acaricides, dinitrophenol fungicides, dinitrophenol herbicides, dinitrophenol insecticides, diphenyl ether herbicides, dithiocarbamate fungicides, dithiocarbamate herbicides, ethylene releasers, fluorine insecticides, formamidine acaricides, formamidine insecticides, fumigant insecticides, furamide fungicides, furanilide fungicides, gibberellins, growth inhibitors, growth retardants, growth stimulators, halogenated aliphatic herbicides, heterocyclic organothiophosphate insecticides, imidazole fungicides, imidazolinone herbicides, indandione rodenticides, inorganic fungicides, inorganic herbicides, inorganic insecticides, inorganic mercury fungicides, inorganic rodenticides, insect growth regulators, isoindole organothiophosphate insecticides, isoxazole organothiophosphate insecticides, juvenile hormone mimics, juvenile hormones, macrocyclic lactone acaricides, macrocyclic lactone insecticides, mercury fungicides, methoxytriazine herbicides, methylthiotriazine herbicides, milbemycin acaricides, milbemycin insecticides, mite growth regulators, morphactins, morpholine fungicides, moulting hormone agonists, moulting hormones, moulting inhibitors, nereistoxin analogue insecticides, nicotinoid insecticides, nitrile herbicides, nitroguanidine insecticides, nitromethylene insecticides, nitrophenyl ether herbicides, organochlorine acaricides, organochlorine insecticides, organochlorine rodenticides, organomercury fungicides, organophosphate acaricides, organophosphate insecticides, organophosphate nematicides, organophosphorus acaricides, organophosphorus fungicides, organophosphorus herbicides, organophosphorus insecticides, organophosphorus nematicides, organophosphorus rodenticides, organothiophosphate acaricides, organothiophosphate insecticides, organothiophosphate nematicides, organotin acaricides, organotin fungicides, oxadiazine insecticides, oxathiin fungicides, oxazole fungicides, oxime carbamate acaricides, oxime carbamate insecticides, oxime carbamate nematicides, oxime organothiophosphate insecticides, phenoxy herbicides, phenoxyacetic herbicides, phenoxybutyric herbicides, phenoxypropionic herbicides, phenyl ethylphosphonothioate insecticides, phenyl methylcarbamate insecticides, phenyl organothiophosphate insecticides, phenyl phenylphosphonothioate insecticides, phenylenediamine herbicides, phenyl pyrazolyl ketone herbicides, phenylsulfamide acaricides, phenylsulfamide fungicides, phenylurea herbicides, phosphonate acaricides, phosphonate insecticides, phosphonothioate insecticides, phosphoramidate insecticides, phosphoramidothioate acaricides, phosphoramidothioate insecticides, phosphorodiamide acaricides, phosphorodiamide insecticides, phthalic acid herbicides, phthalimide acaricides, phthalimide fungides, phthalimide insecticides, picolinic acid herbicides, polymeric dithiocarbamate fungicides, polysulfide fungicides, precocenes, pyrazole acaricides, pyrazole fungicides, pyrazole insecticides, pyrazolopyrimidine organothiophosphate insecticides, pyrazolyloxyacetophenone herbicides, pyrazolylphenyl herbicides, pyrethroid acaricides, pyrethroid ester acaricides, pyrethroid ester insecticides, pyrethroid ether acaricides, pyrethroid ether insecticides, pyrethroid insecticides, pyridazine herbicides, pyridazinone herbicides, pyridine fungicides, pyridine herbicides, pyridine organothiophosphate insecticides, pyridylmethylamine insecticides, pyrimidinamine acaricides, pyrimidinamine insecticides, pyrimidinamine rodenticides, pyrimidine fungicides, pyrimidine organothiophosphate insecticides, pyrimidinediamine herbicides, pyrimidinyloxybenzoic acid herbicides, pyrimidinylsulfonylurea herbicides, pyrimidinylthiobenzoic acid herbicides, pyrrole acaricides, pyrrole fungicides, pyrrole insecticides, quaternary ammonium herbicides, quinoline fungicides, quinolinecarboxylic acid herbicides, quinone fungicides, quinoxaline acaricides, quinoxaline fungicides, quinoxaline organothiophosphate insecticides, strobilurin fungicides, sulfite ester acaricides, sulfonamide fungicides, sulfonamide herbicides, sulfonanilide fungicides, sulfonanilide herbicides, sulfonylurea herbicides, tetrazine acaricides, tetronic acid acaricides, tetronic acid insecticides, thiadiazole organothiophosphate insecticides, thiadiazolylurea herbicides, thiazole fungicides, thiocarbamate acaricides, thiocarbamate fungicides, thiocarbamate herbicides, thiocarbonate herbicides, thiophene fungicides, thiourea acaricides, thiourea herbicides, thiourea rodenticides, triazine fungicides, triazine herbicides, triazinone herbicides, triazinylsulfonylurea herbicides, triazole fungicides, triazole herbicides, triazole organothiophosphate insecticides, triazolone herbicides, triazolopyrimidine herbicides, uracil herbicides, urea fungicides, urea herbicides, urea insecticides, urea rodenticides, valinamide fungicides, xylylalanine fungicides.

In particular, the pesticide is selected from the group of fungicides, herbicides and insecticides.

Herbicides include, for instance, amide herbicides, such as allidochlor, beflubutamid, benzadox, benzipram, bromobutide, cafenstrole, CDEA, chlorthiamid, cyprazole, dimethenamid, dimethenamid-P, diphenamid, epronaz, etnipromid, fentrazamide, flupoxam, fomesafen, halosafen, isocarbamid, isoxaben, napropamide, naptalam, pethoxamid, propyzamide, quinonamid, tebutam; especially anilide herbicides, such as chloranocryl, cisanilide, clomeprop, cypromid, diflufenican, etobenzanid, fenasulam, flufenacet, flufenican, mefenacet, mefluidide, metamifop, monalide, naproanilide, pentanochlor, picolinafen, propanil; in particular arylalanine herbicides, such as benzoylprop, flamprop, flamprop-M; chloroacetanilide herbicides, such as acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor, xylachlor; and sulfonanilide herbicides, such as benzofluor, cloransulam, diclosulam, florasulam, flumetsulam, metosulam, perfluidone, pyrimisulfan, profluazol; and sulfonamide herbicides, such as asulam, carbasulam, fenasulam, oryzalin, penoxsulam; antibiotic herbicides, such as bilanafos; aromatic acid herbicides; especially benzoic acid herbicides, such as chloramben, dicamba, 2,3,6-TBA, tricamba; in particular pyrimidinyloxybenzoic acid herbicides, such as bispyribac, pyriminobac; and pyrimidinylthiobenzoic acid herbicides, such as pyrithiobac; phthalic acid herbicides, such as chlorthal; picolinic acid herbicides, such as aminopyralid, clopyralid, picloram; and quinolinecarboxylic acid herbicides, such as quinclorac, quinmerac; arsenical herbicides, such as cacodylic acid, CMA, DSMA, hexaflurate, MAA, MAMA, MSMA, potassium arsenite, sodium arsenite; benzoylcyclohexanedione herbicides, such as mesotrione, sulcotrione; benzofuranyl alkylsulfonate herbicides, such as benfuresate, ethofumesate; carbamate herbicides, such as asulam, carboxazole, chlorprocarb, dichlormate, fenasulam, karbutilate, terbucarb; carbanilate herbicides, such as barban, BCPC, carbasulam, carbetamide, CEPC, chlorbufam, chlorpropham, CPPC, desmedipham, phenisopham, phenmedipham, phenmedipham-ethyl, propham, swep; cyclohexene oxime herbicides, such as alloxydim, butroxydim, clethodim, cloproxydim, cycloxydim, profoxydim, sethoxydim, tepraloxydim, tralkoxydim; cyclopropylisoxazole herbicides, such as isoxachlortole, isoxaflutole; dicarboximide herbicides, such as benzfendizone, cinidon-ethyl, flumezin, flumiclorac, flumioxazin, flumipropyn; dinitroaniline herbicides, such as benfluralin, butralin, dinitramine, ethalfluralin, fluchloralin, isopropalin, methalpropalin, nitralin, oryzalin, pendimethalin, prodiamine, profluralin, trifluralin; dinitrophenol herbicides, such as dinofenate, dinoprop, dinosam, dinoseb, dinoterb, DNOC, etinofen, medinoterb; diphenyl ether herbicides, such as ethoxyfen; especially nitrophenyl ether herbicides, such as acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen, oxyfluorfen; dithiocarbamate herbicides, such as dazomet, metam; halogenated aliphatic herbicides, such as alorac, chloropon, dalapon, flupropanate, hexachloroacetone, iodomethane, methyl bromide, monochloroacetic acid, SMA, TCA; imidazolinone herbicides, such as imazamethabenz, imazamox, imazapic, imazapyr, imazaquin, imazethapyr; inorganic herbicides, such as ammonium sulfamate, borax, calcium chlorate, copper sulfate, ferrous sulfate, potassium azide, potassium cyanate, sodium azide, sodium chlorate, sulfuric acid; nitrile herbicides, such as bromobonil, bromoxynil, chloroxynil, dichlobenil, iodobonil, ioxynil, pyraclonil; organophosphorus herbicides, such as amiprofos-methyl, anilofos, bensulide, bilanafos, butamifos, 2,4-DEP, DMPA, EBEP, fosamine, glufosinate, glyphosate, piperophos; phenoxy herbicides, such as bromofenoxim, clomeprop, 2,4-DEB, 2,4-DEP, difenopenten, disul, erbon, etnipromid, fenteracol, trifopsime; especially phenoxyacetic herbicides, such as 4-CPA, 2,4-D, 3,4-DA, MCPA, MCPA-thioethyl, 2,4,5-T; phenoxybutyric herbicides, such as 4-CPB, 2,4-DB, 3,4-DB, MCPB, 2,4,5-TB; and phenoxypropionic herbicides, such as cloprop, 4-CPP, dichlorprop, dichlorprop-P, 3,4-DP, fenoprop, mecoprop, mecoprop-P; in particular aryloxyphenoxypropionic herbicides, such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, trifop; phenylenediamine herbicides, such as dinitramine, prodiamine; phenyl pyrazolyl ketone herbicides, such as benzofenap, pyrazolynate, pyrazoxyfen, topramezone; pyrazolylphenyl herbicides, such as fluazolate, pyraflufen; pyridazine herbicides, such as credazine, pyridafol, pyridate; pyridazinone herbicides, such as brompyrazon, chloridazon, dimidazon, flufenpyr, mefflurazon, norflurazon, oxapyrazon, pydanon; pyridine herbicides, such as aminopyralid, cliodinate, clopyralid, dithiopyr, fluoroxypyr, haloxydine, picloram, picolinafen, pyriclor, thiazopyr, triclopyr; pyrimidinediamine herbicides, such as iprymidam, tioclorim; quaternary ammonium herbicides, such as cyperquat, diethamquat, difenzoquat, diquat, morfamquat, paraquat; thiocarbamate herbicides, such as butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate, vernolate; thiocarbonate herbicides, such as dimexano, EXD, proxan; thiourea herbicides, such as methiuron; triazine herbicides, such as dipropetryn, triaziflam, trihydroxytriazine; especially chlorotriazine herbicides, such as atrazine, chlorazine, cyanazine, cyprazine, eglinazine, ipazine, mesoprazine, procyazine, proglinazine, propazine, sebuthylazine, simazine, terbuthylazine, trietazine; methoxytriazine herbicides, such as atraton, methometon, prometon, secbumeton, simeton, terbumeton; and methylthiotriazine herbicides, such as ametryn, aziprotryne, cyanatryn, desmetryn, dimethametryn, methoprotryne, prometryn, simetryn, terbutryn; triazinone herbicides, such as ametridione, amibuzin, hexazinone, isomethiozin, metamitron, metribuzin; triazole herbicides, such as amitrole, cafenstrole, epronaz, flupoxam; triazolone herbicides, such as amicarbazone, carfentrazone, flucarbazone, propoxycarbazone, sulfentrazone; triazolopyrimidine herbicides, such as cloransulam, diclosulam, florasulam, flumetsulam, metosulam, penoxsulam; uracil herbicides, such as butafenacil, bromacil, flupropacil, isocil, lenacil, terbacil; urea herbicides, such as benzthiazuron, cumyluron, cycluron, dichloralurea, diflufenzopyr, isonoruron, isouron, methabenzthiazuron, monisouron, noruron; especially phenylurea herbicides, such as anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluoron, phenobenzuron, siduron, tetrafluoron, thidiazuron; sulfonylurea herbicides; in particular pyrimidinylsulfonylurea herbicides, such as amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, orthosulfamuron, oxasulfuron, primisulfuron, pyrazosulfuron, rimsulfuron, sulfometuron, sulfosulfuron, trifloxysulfuron; and triazinylsulfonylurea herbicides, such as chlorsulfuron, cinosulfuron, ethametsulfuron, iodosulfuron, metsulfuron, prosulfuron, thifensulfuron, triasulfuron, tribenuron, triflusulfuron, tritosulfuron; and thiadiazolylurea herbicides, such as buthiuron, ethidimuron, tebuthiuron, thiazafluoron, thidiazuron; and unclassified herbicides, such as acrolein, allyl alcohol, azafenidin, benazolin, bentazone, benzobicyclon, buthidazole, calcium cyanamide, cambendichlor, chlorfenac, chlorfenprop, chlorflurazole, chlorflurenol, cinmethylin, clomazone, CPMF, cresol, ortho-dichlorobenzene, dimepiperate, endothal, fluoromidine, fluridone, fluorochloridone, flurtamone, fluthiacet, indanofan, methazole, methyl isothiocyanate, nipyraclofen, OCH, oxadiargyl, oxadiazon, oxaziclomefone, pentachlorophenol, pentoxazone, phenylmercury acetate, pinoxaden, prosulfalin, pyribenzoxim, pyriftalid, quinoclamine, rhodethanil, sulglycapin, thidiazimin, tridiphane, trimeturon, tripropindan, tritac.

According to a particular embodiment of the present invention, herbicides include:
1,3,4-thiadiazoles, such as buthidazole and cyprazole;
amides, such as allidochlor, benzoylprop-ethyl, bromobutide, chlorthiamid, dimepiperate, dimethenamid, diphenamid, etobenzanid, flamprop, flamprop-methyl, fosamine, isoxaben, metazachlor, monalide, naptalam, pronamide, propanil, propyzamide, quinonamid;
aminotriazoles, such as amitrole,
anilides, such as anilofos, mefenacet, pentanochlor;
aryloxyalkanoic acids, such as 2,4-D, 2,4-DB, clomeprop, dichlorprop, dichlorprop-P, fenoprop, fluoroxypyr, MCPA, MCPB, mecoprop, mecoprop-P, napropamide, napropanilide, triclopyr;
benzoic acids, such as chloramben, dicamba;
benzothiadiazinones, such as bentazone;
bleachers, such as clomazone, diflufenican, fluorochloridone, flupoxam, fluridone, karbutilate, pyrazolate, sulcotrione, mesotrione;
carbamates, such as asulam, carbetamide, chlorbufam, chlorpropham, desmedipham, phenmedipham, vernolate;
quinolinic acids, such as quinclorac, quinmerac;
dichloropropionic acids, such as dalapon;
dihydrobenzofurans, such as ethofumesate;
dihydrofuran-3-ones, such as flurtamone;
dinitroanilines, such as benefin, butralin, dinitramine, ethalfluralin, fluchloralin, isopropalin, nitralin, oryzalin, pendimethalin, prodiamine, profluralin, trifluralin;
dinitrophenols, such as bromofenoxim, dinoseb, dinoseb-acetate, dinoterb, DNOC, minoterb-acetate;
diphenyl ethers, such as acifluorofen, acifluorfen-sodium, aclonifen, bifenox, chlornitrofen, difenoxuran, ethoxyfen, fluorodifen, fluoroglycofen-ethyl, fomesafen, furyloxyfen, lactofen, nitrofen, nitrofluorfen, oxyfluorfen;
ureas, such as benzthiazuron, DCU, diflufenzopyr, methabenzthiazuron;
imidazolinones, such as imazamethapyr, imazapyr, imazaquin, imazethabenz-methyl, imazethapyr, imazapic, imazamox;
oxadiazoles, such as methazole, oxadiargyl, oxadiazon;
oxiranes, such as tridiphane;
phenols, such as bromoxynil, ioxynil;
phenoxyphenoxypropionic acid esters, such as clodinafop, cyhalofop-butyl, diclofop-methyl, fenoxaprop-ethyl, fenoxaprop-p-ethyl, fenthiaprop-ethyl, fluazifop-butyl, fluazifop-p-butyl, haloxyfop-ethoxyethyl, haloxyfop-methyl, haloxyfop-p-methyl, isoxapyrifop, propaquizafop, quizalofop-ethyl, quizalofop-p-ethyl, quizalofop-tefuryl;
phenylacetic acids, such as chlorfenac;
phenylureas, such as buturon, chlorotoluron, chlorbromuron, chloroxuron, dimefuron, diuron, fenuron, isoproturon, linuron, monolinuron, monuron, metobenzuron, metobromuron, metoxuron, neburon;
phenylpropionic acids, such as chlorophenprop-methyl;
ppi-active compounds, such as benzofenap, flumiclorac, flumiclorac-pentyl, flumioxazine, flumipropyn, flupropacil, pyrazoxyfen, sulfentrazone, thidiazimin;
pyrazoles, such as nipyraclofen;
pyridoxines, such as chloridazon, maleic hydrazide, norflurazon, pyridate;
pyridinecarboxylic acids, such as clopyralid, dithiopyr, picloram, thiazopyr;
pyrimidyl ethers, such as pyrithiobac-acid, pyrithiobac-sodium, KIH-2023, KIH-6127;
sulfonamides, such as flumetsulam, metosulam;
sulfonylureas, such as amidosulfuron, azimsulfuron, bensulfuron-methyl, chlorimuron-ethyl, chlorsulfuron, cinosulfuron, cyclosulfamuron, ethyoxysulfuron, ethametsulfuron-methyl, flazasulfuron, flupyrsulfuron-methyl, foramsulfuron, halosulfuron-methyl, imazosulfuron, iodosulfuron, metsulfuron-methyl, nicosulfuron, oxasulfuron, primisulfuron, prosulfuron, pyrazosulfuron-ethyl, rimsulfuron, sulfometuron-methyl, sulfosulfuron, thifensulfuron-methyl, triasulfuron, tribenuron-methyl, triflusulfuron-methyl, tritosulfuron;
thiadiazolylureas, such as ethidimuron, tebuthiuron, thiazafluoron;
triazines, such as ametryn, atrazine, atraton, cyanazine, cyprazine, desmetryn, dipropetryn, isomethiozin, propazine, promethryn, prometon, sebuthylazine, secbumethon, simazine, tebutryn, terbumeton, terbuthylazine, trietazine;
triazolecarboxamides, such as triazofenamide;
uracils, such as bromacil, butafenacil, lenacil, terbacil;
furthermore azafenidin, aziprotryne, bromuron, benazolin, benfuresate, bensulide, benzofluor, bentazon, bromofenoxim, butamifos, cafenstrole, chlorthal-dimethyl, cinmethylin, cinidon-ethyl, defenuron, dichlobenil, endothall, fluorbentranil, fluthiacet-methyl, inxynil, isoxaflutole, mefluidide, methazole, metribuzin, metramitron, perfluidone, piperophos, topramezone;
crop protection agents of the cyclohexenone type, such as alloxydim, clethodim, cloproxydim, cycloxydim, sethoxydim and tralkoxydim. Particularly preferred herbicidally active compounds of the cyclohexenone type are: tepraloxydim (cf. AGROW, No. 243, 11.3.95, page 21, caloxydim) and 2-(1-[2-{4-chlorophenoxy}-propyloxyimino]butyl)-3-hydroxy-5-(2H-tetrahydrothiopyran-3-yl)-2-cyclohexen-1-one, and a particularly preferred herbicidally active compound of the sulfonylurea type is: N—(((4-methoxy-6-[trifluoromethyl]-1,3,5-triazin-2-yl)amino)carbonyl)-2-(trifluoromethyl)benzenesulfonamide.

Fungicides include, for instance, aliphatic nitrogen fungicides, such as butylamine, cymoxanil, dodicin, dodine, guazatine, iminoctadine; amide fungicides, such as carpropamid, chloraniformethan, cyflufenamid, diclocymet, ethaboxam, fenoxanil, flumetover, furametpyr, mandipropamid, penthiopyrad, prochloraz, quinazamid, silthiofam, triforine; especially acylamino acid fungicides, such as benalaxyl, benalaxyl-M, furalaxyl, metalaxyl, metalaxyl-M, pefurazoate; anilide fungicides, such as benalaxyl, benalaxyl-M, boscalid, carboxin, fenhexamid, metalaxyl, metalaxyl-M, metsulfovax, ofurace, oxadixyl, oxycarboxin, pyracarbolid, thifluzamide, tiadinil; in particular benzanilide fungicides, such as benodanil, flutolanil, mebenil, mepronil, salicylanilide, tecloftalam; furanilide fungicides, such as fenfuram, furalaxyl, furcarbanil, methfuroxam; and sulfonanilide fungicides, such as flusulfamide; benzamide fungicides, such as benzohydroxamic acid, fluopicolide, tioxymid, trichlamide, zarilamid, zoxamide; furamide fungicides, such as cyclafuramid, furmecyclox; phenylsulfamide fungicides, such as dichlofluanid, tolylfluanid; sulfonamide fungicides, such as cyazofamid; and valinamide fungicides, such as benthiavalicarb, iprovalicarb; antibiotic fungicides, such as aureofungin, blasticidin-S, cycloheximide, griseofulvin, kasugamycin, natamycin, polyoxins, polyoxorim, streptomycin, validamycin; especially strobilurin fungicides, such as azoxystrobin, dimoxystrobin, fluoxastrobin, kresoxim-methyl, metominostrobin, orysastrobin, picoxystrobin, pyraclostrobin, trifloxystrobin; aromatic fungicides, such as biphenyl, chlorodinitronaphthalene, chloroneb, chlorothalonil, cresol, dicloran, hexachlorobenzene, pentachlorophenol, quintozene, sodium pentachlorophenoxide, tecnazene; benzimidazole fungicides, such as benomyl, carbendazim, chlorfenazole, cypendazole, debacarb, fuberidazole, mecarbinzid, rabenzazole, thiabendazole; benzimidazole precursor fungicides, such as furophanate, thiophanate, thiophanate-methyl; benzothiazole fungicides, such as bentaluron, chlobenthiazone, TCMTB; bridged diphenyl fungicides, such as bithionol, dichlorophen, diphenylamine; carbamate fungicides, such as benthiavalicarb, furophanate, iprovalicarb, propamocarb, thiophanate, thiophanate-methyl; especially benzimidazolylcarbamate fungicides, such as benomyl, carbendazim, cypendazole, debacarb, mecarbinzid; and carbanilate fungicides, such as diethofencarb; conazole fungicides; especially conazole fungicides (imidazoles), such as climbazole, clotrimazole, imazalil, oxpoconazole, prochloraz, triflumizole; and conazole fungicides (triazoles), such as azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P; copper fungicides, such as Bordeaux mixture, Burgundy mixture, Cheshunt mixture, copper acetate, copper carbonate, basic, copper hydroxide, copper naphthenate, copper oleate, copper oxychloride, copper sulfate, copper sulfate, basic, copper zinc chromate, cufraneb, cuprobam, cuprous oxide, mancopper, oxine copper; dicarboximide fungicides, such as famoxadone, fluoroimide; especially dichlorophenyl dicarboximide fungicides, such as chlozolinate, dichlozoline, iprodione, isovaledione, myclozolin, procymidone, vinclozolin; and phthalimide fungicides, such as captafol, captan, ditalimfos, folpet, thiochlorfenphim; dinitrophenol fungicides, such as binapacryl, dinobuton, dinocap, dinocap-4, dinocap-6, dinocton, dinopenton, dinosulfon, dinoterbon, DNOC; dithiocarbamate fungicides, such as azithiram, carbamorph, cufraneb, cuprobam, disulfuram, ferbam, metam, nabam, tecoram, thiram, ziram; especially cyclic dithiocarbamate fungicides, such as dazomet, etem, milneb; and polymeric dithiocarbamate fungicides, such as mancopper, mancozeb, maneb, metiram, polycarbamate, propineb, zineb; imidazole fungicides, such as cyazofamid, fenamidone, fenapanil, glyodin, iprodione, isovaledione, pefurazoate, triazoxide; inorganic fungicides, such as potassium azide, potassium thiocyanate, sodium azide, sulfur; mercury fungicides; especially inorganic mercury fungicides, such as mercuric chloride, mercuric oxide, mercurous chloride; and organomercury fungicides, such as (3-ethoxypropyl)mercury bromide, ethylmercury acetate, ethylmercury bromide, ethylmercury chloride, ethylmercury 2,3-dihydroxypropyl mercaptide, ethylmercury phosphate, N-(ethylmercury)-p-toluenesulphonanilide, hydrargaphen, 2-methoxyethylmercury chloride, methylmercury benzoate, methylmercury dicyandiamide, methylmercury pentachlorophenoxide, 8-phenylmercurioxyquinoline, phenylmercuriurea, phenylmercury acetate, phenylmercury chloride, phenylmercury derivative of pyrocatechol, phenylmercury nitrate, phenylmercury salicylate, thiomersal, tolylmercury acetate; morpholine fungicides, such as aldimorph, benzamorf, carbamorph, dimethomorph, dodemorph, fenpropimorph, flumorph, tridemorph; organophosphorus fungicides, such as ampropylfos, ditalimfos, edifenphos, fosetyl, hexylthiofos, iprobenfos, phosdiphen, pyrazophos, tolclofos-methyl, triamiphos; organotin fungicides, such as decafentin, fentin, tributyltin oxide; oxathiin fungicides, such as carboxin, oxycarboxin; oxazole fungicides, such as chlozolinate, dichlozoline, drazoxolon, famoxadone, hymexazol, metazoxolon, myclozolin, oxadixyl, vinclozolin; polysulfide fungicides, such as barium polysulfide, calcium polysulfide, potassium polysulfide, sodium polysulfide; pyrazole fungicides, such as furametpyr, penthiopyrad; pyridine fungicides, such as boscalid, buthiobate, dipyrithione, fluazinam, fluopicolide, pyridinitril, pyrifenox, pyroxychlor, pyroxyfur; pyrimidine fungicides, such as bupirimate, cyprodinil, diflumetorim, dimethirimol, ethirimol, fenarimol, ferimzone, mepanipyrim, nuarimol, pyrimethanil, triarimol; pyrrole fungicides, such as fenpiclonil, fludioxonil, fluoroimide; quinoline fungicides, such as ethoxyquin, halacrinate, 8-hydroxyquinoline sulfate, quinacetol, quinoxyfen; quinone fungicides, such as benquinox, chloranil, dichlone, dithianon; quinoxaline fungicides, such as chinomethionat, chlorquinox, thioquinox; thiazole fungicides, such as ethaboxam, etridiazole, metsulfovax, octhilinone, thiabendazole, thiadifluor, thifluzamide; thiocarbamate fungicides, such as methasulfocarb, prothiocarb; thiophene fungicides, such as ethaboxam, silthiofam; triazine fungicides, such as anilazine; triazole fungicides, such as bitertanol, fluotrimazole, triazbutil; urea fungicides, such as bentaluron, pencycuron, quinazamid; unclassified fungicides, such as acibenzolar, acypetacs, allyl alcohol, benzalkonium chloride, benzamacril, bethoxazin, carvone, chloropicrin, DBCP, dehydroacetic acid, diclomezine, diethyl pyrocarbonate, fenaminosulf, fenitropan, fenpropidin, formaldehyde, furfural, hexachlorobutadiene, iodomethane, isoprothiolane, methyl bromide, methyl isothiocyanate, metrafenone, nitrostyrene, nitrothal-isopropyl, OCH, 2-phenylphenol, phthalide, piperalin, probenazole, proquinazid, pyroquilon, sodium orthophenylphenoxide, spiroxamine, sultropen, thicyofen, tricyclazole, zinc naphthenate. According to a particular embodiment of the present invention, fungicides include:
acylalanines, such as benalaxyl, metalaxyl, ofurace, oxadixyl;
amine derivatives, such as aldimorph, dodine, dodemorph, fenpropimorph, fenpropidin, guazatine, iminoctadine, spiroxamine, tridemorph;
anilinopyrimidines, such as pyrimethanil, mepanipyrim or cyprodinil;
antibiotics, such as cycloheximide, griseofulvin, kasugamycin, natamycin, polyoxin and streptomycin;
azoles: azaconazole, bitertanol, bromoconazole, cyproconazole, dichlobutrazole, difenoconazole, dinitroconazole, epoxiconazole, fenbuconazole, fluquinconazole, flusilazole, flutriafol, ketoconazole, hexaconazole, metconazole, myclobutanil, penconazole, propiconazole, prothioconazole, tebuconazole, tetraconazole, triadimefon, triadimenol, triflumizole, triticonazole;
dicarboximides, such as iprodione, myclozolin, procymidone, vinclozolin;
dithiocarbamates: ferbam, nabam, maneb, mancozeb, metam, metiram, propineb, polycarbamate, thiram, ziram, zineb;
heterocyclic compounds, such as anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolane, mepronil, nuarimol, probenazole, proquinazid, pyrifenox, pyroquilon, quinoxyfen, silthiofam, thiabendazole, thifluzamide, thiophenate-methyl, tiadinil, tricyclazole, triforine;
nitrophenyl derivatives, such as binapacryl, dinocap, dinobuton, nitrophthal-isopropyl;
phenylpyrroles, such as fenpiclonil and also fludioxonil;
2-methoxybenzophenones as described in EP-A 897904 by the general formula I, for example metrafenone;
fungicides not belonging to any of the other classes, such as acibenzolar-S-methyl, benthiavalicarb, carpropamid, chlorothalonil, cyflufenamid, cymoxanil, diclomezine, diclocymet, diethofencarb, edifenphos, ethaboxam, fenhexamid, fentin-acetate, fenoxanil, ferimzone, fluazinam, fosetyl, foestyl-aluminum, iprovalicarb, hexachlorobenzol, metrafenone, pencycuron, propamocarb, phthalide, toloclofos-methyl, quintozene, zoxamide;
strobilurins as described in WO 03/075663 by the general formula I, for example: azoxystrobin, dimoxystrobin, fluoxastrobin, kresoxim-methyl, metominostrobin, orysastrobin, picoxystrobin, pyraclostrobin and trifloxystrobin;
sulfenic acid derivatives, such as captafol, captan, dichlofluanid, folpet, tolylfluanid;
cinnamides and analogs thereof, such as dimethomorph, flumetover, flumorph;
6-aryl-[1,2,4]triazolo[1,5-a]pyrimidines as described, for example, in WO 98/46608, WO 99/41255 or WO 03/004465 in each case by the general formula I, for example 5-chloro-7-(4-methylpiperidin-1-yl)-6-(2,4,6-trifluorophenyl)-[1, 2,4]triazolo[1,5-a]pyrimidine, 5-chloro-7-(4-methylpiperazin-1-yl)-6-(2,4,6-trifluorophenyl)-[1, 2,4]triazolo[1,5-a]pyrimidine, 5-chloro-7-(morpholin-1-yl)-6-(2,4,6-trifluorophenyl)-[1,2,4]triazolo[1,5-a]pyrimidine, 5-chloro-7-(piperidin-1-yl)-6-(2,4,6-trifluorophenyl)-[1,2,4]triazolo[1,5-a]pyrimidine, 5-chloro-7-(morpholin-1-yl)-6-(2,4,6-trifluorophenyl)-[1,2,4]triazolo[1,5-a]pyrimidine, 5-chloro-7-(isopropylamino)-6-(2,4,6-trifluorophenyl)-[1,2,4]triazolo[1,5-a]pyrimidine, 5-chloro-7-(cyclopentylamino)-6-(2,4,6-trifluorophenyl)-[1, 2,4]triazolo[1,5-a]pyrimidine, 5-chloro-7-(2,2,2-trifluoroethylamino)-6-(2,4,6-trifluorophenyl)-[1,2,4]triazolo[1,5-a]pyrimidine, 5-chloro-7-(1,1,1-trifluoropropan-2-ylamino)-6-(2,4,6-trifluorophenyl)-[1,2,4]triazolo[1,5-a]pyrimidine, 5-chloro-7-(3,3-dimethylbutan-2-ylamino)-6-(2,4,6-trifluorophenyl)-[1, 2,4]triazolo[1,5-a]pyrimidine, 5-chloro-7-(cyclohexylmethyl)-6-(2,4,6-trifluorophenyl)-[1,2,4]triazolo[1,5-a]pyrimidine, 5-chloro-7-(cyclohexyl)-6-(2,4,6-trifluorophenyl)-[1,2,4]triazolo[1,5-a]pyrimidine, 5-chloro-7-(2-methylbutan-3-yl)-6-(2,4,6-trifluorophenyl)-[1,2,4]triazolo[1,5-a]pyrimidine, 5-chloro-7-(3-methylpropan-1-yl)-6-(2,4,6-trifluorophenyl)-[1,2,4]triazolo[1,5-a]pyrimidine, 5-chloro-7-(4-methylcyclohexan-1-yl)-6-(2,4,6-trifluorophenyl)-[1, 2,4]triazolo[1,5-a]pyrimidine, 5-chloro-7-(hexan-3-yl)-6-(2,4,6-trifluorophenyl)-[1,2,4]triazolo[1,5-a]pyrimidine, 5-chloro-7-(2-methylbutan-1-yl)-6-(2,4,6-trifluorophenyl)-[1, 2,4]triazolo[1,5-a]pyrimidine, 5-chloro-7-(3-methylbutan-1-yl)-6-(2,4,6-trifluorophenyl)-[1,2,4]triazolo[1,5-a]pyrimidine, 5-chloro-7-(1-methylpropan-1-yl)-6-(2,4,6-trifluorophenyl)-[1, 2,4]triazolo[1,5-a]pyrimidine, 5-methyl-7-(4-methylpiperidin-1-yl)-6-(2,4,6-trifluorophenyl)-[1,2,4]triazolo[1,5-a]pyrimidine, 5-methyl-7-(4-methylpiperazin-1-yl)-6-(2,4,6-trifluorophenyl)-[1,2,4]triazolo[1,5-a]pyrimidine, 5-methyl-7-(morpholin-1-yl)-6-(2,4,6-trifluorophenyl)-[1,2,4]triazolo[1,5-a]pyrimidine, 5-methyl-7-(piperidin-1-yl)-6-(2,4,6-trifluorophenyl)-[1,2,4]triazolo[1,5-a]pyrimidine, 5-methyl-7-(morpholin-1-yl)-6-(2,4,6-trifluorophenyl)-[1,2,4]triazolo[1,5-a]pyrimidine, 5-methyl-7-(isopropylamino)-6-(2,4,6-trifluorophenyl)-[1,2,4]triazolo[1,5-a]pyrimidine, 5-methyl-7-(cyclopentylamino)-6-(2,4,6-trifluorophenyl)-[1,2,4]triazolo[1,5-a]pyrimidine, 5-methyl-7-(2,2,2-trifluorethylamino)-6-(2,4,6-trifluorophenyl)-[1,2,4]triazolo[1,5-a]pyrimidine, 5-methyl-7-(1,1,1-trifluoropropan-2-ylamino)-6-(2,4,6-trifluorophenyl)-[1,2,4]triazolo[1,5-a]pyrimidine, 5-methyl-7-(3,3-dimethylbutan-2-ylamino)-6-(2,4,6-trifluorophenyl)-[1,2,4]triazolo[1,5-a]pyrimidine, 5-methyl-7-(cyclohexylmethyl)-6-(2,4,6-trifluorophenyl)-[1, 2,4]triazolo[1,5-a]pyrimidine, 5-methyl-7-(cyclohexyl)-6-(2,4,6-trifluorophenyl)-[1,2,4]triazolo[1,5-a]pyrimidine, 5-methyl-7-(2-methylbutan-3-yl)-6-(2,4,6-trifluorophenyl)-[1,2,4]triazolo[1,5-a]pyrimidine, 5-methyl-7-(3-methylpropan-1-yl)-6-(2,4,6-trifluorophenyl)-[1,2,4]triazolo[1,5-a]pyrimidine, 5-methyl-7-(4-methylcyclohexan-1-yl)-6-(2,4,6-trifluorophenyl)-[1, 2,4]triazolo[1,5-a]pyrimidine, 5-methyl-7-(hexan-3-yl)-6-(2,4,6-trifluorophenyl)-[1,2,4]triazolo[1,5-a]pyrimidine, 5-methyl-7-(2-methylbutan-1-yl)-6-(2,4,6-trifluorophenyl)-[1,2,4]triazolo[1,5-a]pyrimidine, 5-methyl-7-(3-methylbutan-1-yl)-6-(2,4,6-trifluorophenyl)-[1,2,4]triazolo[1,5-a]pyrimidine and 5-methyl-7-(1-methylpropan-1-yl)-6-(2,4,6-trifluorophenyl)-[1, 2,4]triazolo[1,5-a]pyrimidine;
amide fungicides, such as cyclofenamid, and also (Z)-N-[α-(cyclopropylmethoxy-imino)-2,3-difluoro-6-(difluoromethoxy)benzyl]-2-phenylacetamide.

Insecticides include, for instance antibiotic insecticides, such as allosamidin, thuringiensin; especially macrocyclic lactone insecticides, such as spinosad; in particular avermectin insecticides, such as abamectin, doramectin, emamectin, eprinomectin, ivermectin, selamectin; and milbemycin insecticides, such as lepimectin, milbemectin, milbemycin oxime, moxidectin; arsenical insecticides, such as calcium arsenate, copper acetoarsenite, copper arsenate, lead arsenate, potassium arsenite, sodium arsenite; botanical insecticides, such as anabasine, azadirachtin, d-limonene, nicotine, pyrethrins, cinerins, cinerin I, cinerin II, jasmolin I, jasmolin II, pyrethrin I, pyrethrin II, quassia, rotenone, ryania, sabadilla; carbamate insecticides, such as bendiocarb, carbaryl; especially benzofuranyl methylcarbamate insecticides, such as benfuracarb, carbofuran, carbosulfan, decarbofuran, furathiocarb; dimethylcarbamate insecticides, such as dimetan, dimetilan, hyquincarb, pirimicarb; oxime carbamate insecticides, such as alanycarb, aldicarb, aldoxycarb, butocarboxim, butoxycarboxim, methomyl, nitrilacarb, oxamyl, tazimcarb, thiocarboxime, thiodicarb, thiofanox; and phenyl methylcarbamate insecticides, such as allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC, xylylcarb; dinitrophenol insecticides, such as dinex, dinoprop, dinosam, DNOC; fluorine insecticides, such as barium hexafluorosilicate, cryolite, sodium fluoride, sodium hexafluorosilicate, sulfluramid; formamidine insecticides, such as amitraz, chlordimeform, formetanate, formparanate; fumigant insecticides, such as acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, iodomethane, methyl bromide, methylchloroform, methylene chloride, naphthalene, phosphine, sulfuryl fluoride, tetrachloroethane; inorganic insecticides, such as borax, calcium polysulfide, copper oleate, mercurous chloride, potassium thiocyanate, sodium thiocyanate; insect growth regulators; especially chitin synthesis inhibitors, such as bistrifluoron, buprofezin, chlorfluazuron, cyromazine, diflubenzuron, flucycloxuron, flufenoxuron, hexaflumuron, lufenuron, novaluron, noviflumuron, penfluoron, teflubenzuron, triflumuron; juvenile hormone mimics, such as epofenonane, fenoxycarb, hydroprene, kinoprene, methoprene, pyriproxyfen, triprene; juvenile hormones, such as juvenile hormone I, juvenile hormone II, juvenile hormone III; moulting hormone agonists, such as chromafenozide, halofenozide, methoxyfenozide, tebufenozide; moulting hormones, such as α-ecdysone, ecdysterone; moulting inhibitors, such as diofenolan; precocenes, such as precocene I, precocene II, precocene II; and unclassified insect growth regulators, such as dicyclanil; nereistoxin analogue insecticides, such as bensultap, cartap, thiocyclam, thiosultap; nicotinoid insecticides, such as flonicamid; especially nitroguanidine insecticides, such as clothianidin, dinotefuran, imidacloprid, thiamethoxam; nitromethylene insecticides, such as nitenpyram, nithiazine; and pyridylmethylamine insecticides, such as acetamiprid, imidacloprid, nitenpyram, thiacloprid; organochlorine insecticides, such as bromo-DDT, camphechlor, DDT, pp′-DDT, ethyl-DDD, HCH, gamma-HCH, lindane, methoxychlor, pentachlorophenol, TDE; especially cyclodiene insecticides, such as aldrin, bromocyclen, chlorbicyclen, chlordane, chlordecone, dieldrin, dilor, endosulfan, endrin, HEOD, heptachlor, HHDN, isobenzan, isodrin, kelevan, mirex; organophosphorus insecticides; especially organophosphate insecticides, such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, TEPP, tetrachlorvinphos; organothiophosphate insecticides, such as dioxabenzofos, fosmethilan, phenthoate; in particular aliphatic organothiophosphate insecticides, such as acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, IPSP, isothioate, malathion, methacrifos, oxydemeton-methyl, oxydeprofos, oxydisulfoton, phorate, sulfotep, terbufos, thiometon; more particularly aliphatic amide organothiophosphate insecticides, such as amidithion, cyanthoate, dimethoate, ethoate-methyl, formothion, mecarbam, omethoate, prothoate, sophamide, vamidothion; and oxime organothiophosphate insecticides, such as chlorphoxim, phoxim, phoxim-methyl; heterocyclic organothiophosphate insecticides, such as azamethiphos, coumaphos, coumithoate, dioxathion, endothion, menazon, morphothion, phosalone, pyraclofos, pyridaphenthion, quinothion; more particularly benzothiopyran organothiophosphate insecticides, such as dithicrofos, thicrofos; benzotriazine organothiophosphate insecticides, such as azinphos-ethyl, azinphos-methyl; isoindole organothiophosphate insecticides, such as dialifos, phosmet; isoxazole organothiophosphate insecticides, such as isoxathion, zolaprofos; pyrazolopyrimidine organothiophosphate insecticides, such as chlorprazophos, pyrazophos; pyridine organothiophosphate insecticides, such as chlorpyrifos, chlorpyrifos-methyl; pyrimidine organothiophosphate insecticides, such as butathiofos, diazinon, etrimfos, lirimfos, pirimiphos-ethyl, pirimiphos-methyl, primidophos, pyrimitate, tebupirimfos; quinoxaline organothiophosphate insecticides, such as quinalphos, quinalphos-methyl; thiadiazole organothiophosphate insecticides, such as athidathion, lythidathion, methidathion, prothidathion; and triazole organothiophosphate insecticides, such as isazofos, triazophos; and phenyl organothiophosphate insecticides, such as azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3, trifenofos; phosphonate insecticides, such as butonate, trichlorfon; phosphonothioate insecticides, such as mecarphon; in particular phenyl ethylphosphonothioate insecticides, such as fonofos, trichloronat; and phenyl phenylphosphonothioate insecticides, such as cyanofenphos, EPN, leptophos; phosphoramidate insecticides, such as crufomate, fenamiphos, fosthietan, mephosfolan, phosfolan, pirimetaphos; phosphoramidothioate insecticides, such as acephate, isocarbophos, isofenphos, methamidophos, propetamphos; and phosphorodiamide insecticides, such as dimefox, mazidox, mipafox, schradan; oxadiazine insecticides, such as indoxacarb; phthalimide insecticides, such as dialifos, phosmet, tetramethrin; pyrazole insecticides, such as acetoprole, ethiprole, fipronil, pyrafluprole, pyriprole, tebufenpyrad, tolfenpyrad, vaniliprole; pyrethroid insecticides; especially pyrethroid ester insecticides, such as acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin; and pyrethroid ether insecticides, such as etofenprox, flufenprox, halfenprox, protrifenbute, silafluofen; pyrimidinamine insecticides, such as flufenerim, pyrimidifen; pyrrole insecticides, such as chlorfenapyr; tetronic acid insecticides, such as spiromesifen; thiourea insecticides, such as diafenthiuron; urea insecticides, such as flucofuron, sulcofuron; unclassified insecticides, such as closantel, crotamiton, EXD, fenazaflor, fenoxacrim, flubendiamide, hydramethylnon, isoprothiolane, malonoben, metaflumizone, metoxadiazone, nifluridide, pyridaben, pyridalyl, rafoxanide, triarathene, triazamate.

According to a particular embodiment of the present invention, insecticides include:
organophosphates, such as azinphos-methyl, azinphos-ethyl, chlorpyrifos, chlorpyrifos-methyl, chlorfenvinphos, diazinon, dimethylvinphos, dioxabenzofos, disulfoton, ethion, EPN, fenitrothion, fenthion, heptenophos, isoxathion, malathion, methidathion, methyl-parathion, paraoxon, parathion, phenthoate, phosalone, phosmet, phorate, phoxim, pirimiphos-methyl, profenofos, prothiofos, primiphos-ethyl, pyraclofos, pyridaphenthion, sulprofos, triazophos, trichlorfon, tetrachlorvinphos, vamidothion;
carbamates, such as alanycarb, benfuracarb, bendiocarb, carbaryl, carbofuran, carbosulfan, fenoxycarb, furathiocarb, indoxacarb, methiocarb, pirimicarb, propoxur, thiodicarb, triazamate;
pyrethroids, such as bifenthrin, cyfluthrin, cycloprothrin, cypermethrin, deltamethrin, esfenvalerate, ethofenprox, fenpropathrin, fenvalerate, cyhalothrin, lambda-cyhalothrin, permethrin, silafluofen, tau-fluvalinate, tefluthrin, tralomethrin, alpha-cypermethrin, permethrin;
arthropod growth regulators: a) chitin synthesis inhibitors, for example benzoylureas, such as chlorfluazuron, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists, such as halofenozide, methoxyfenozide, tebufenozide; c) juvenoids, such as pyriproxyfen, methoprene; d) lipid biosynthesis inhibitors, such as spirodiclofen;
neonicotinoids, such as flonicamid, clothianidin, dinotefuran, imidacloprid, thiamethoxam, nithiazine, acetamiprid, thiacloprid;
further insecticides which do not belong to the above classes, such as abamectin, acequinocyl, acetamiprid, amitraz, azadirachtin, bensultap, bifenazate, cartap, chlorfenapyr, chlordimeform, diafenthiuron, dinetofuran, diofenolan, emamectin, endosulfan, ethiprole, fenazaquin, fipronil, formetanate, formetanate hydrochloride, gamma-HCH, hydramethylnon, imidacloprid, indoxacarb, isoprocarb, metolcarb, pyridaben, pymetrozine, spinosad, tebufenpyrad, thiamethoxam, XMC and xylylcarb and
N-phenylsemicarbazones as described in EP-A 462 456 by the formula I, in particular compounds of the general formula IV

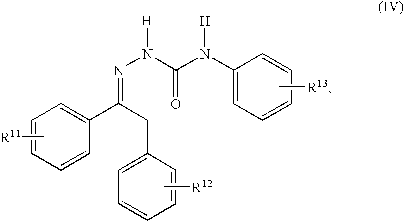

in which R¹¹ and R¹² independently of one another are hydrogen, halogen, CN, C₁-C₄-alkyl, C₁-C₄-alkoxy, C₁-C₄-haloalkyl or C₁-C₄-haloalkoxy and R¹³ is C₁-C₄-alkoxy, C₁-C₄-haloalkyl or C₁-C₄-haloalkoxy, for example compounds IV in which R¹¹ is 3-CF₃ and R¹² is 4-CN and R¹³ is 4-OCF₃;

According to a particular aspect of the invention, the pesticide can be a neutral or ionic (anionic or cationic) compound, an acidic or basic compound, optionally in the form an acid or base addition salt, a polar or a polar compound.

Particular pesticides are selected from the group consisting of phenoxyacetic herbicides and plant growth regulators such as (2,4-dichlorophenoxy)acetic acid;

nitrophenyl ether herbicides such as 5-(2-chloro-α,α,α-trifluoro-p-tolyloxy)-2-nitrobenzoic acid; pyrethroid ester acaricides and insecticides such as the racemate comprising (R)-α-cyano-3-phenoxybenzyl (1S,3S)-3-(2,2-dichlorovinyl)-2,2-dimethylcyclopropanecarboxylate and (S)-α-cyano-3-phenoxybenzyl (1R,3R)-3-(2,2-dichlorovinyl)-2,2-dimethylcyclopropanecarboxylate, the racemate comprising (R)-α-cyano-3-phenoxybenzyl (1S)-cis-3-(2,2-dichlorovinyl)-2,2-dimethylcyclopropanecarboxylate and (S)-α-cyano-3-phenoxybenzyl (1R)-cis-3-(2,2-dichlorovinyl)-2,2-dimethylcyclopropane carboxylate; further herbicides such as 3-isopropyl-1H-2,1,3-benzothiadiazin-4(3H)-one 2,2-dioxide; anilide fungicides and pyridine fungicides such as 2-chloro-N-(4′-chlorobiphenyl-2-yl)nicotinamide; benzimidazole fungicides and benzimidazolylcarbamate fungicides such as methyl benzimidazol-2-ylcarbamate; pyrrole acaricides and insecticides such as 4-bromo-2-(4-chlorophenyl)-1-ethoxymethyl-5-(trifluoromethyl)pyrrole-3-carbonitrile; organophosphate acaricides and insecticides such as (EZ)-2-chloro-1-(2,4-dichloro phenyl)vinyl diethyl phosphate; pyridazinone herbicides such as 5-amino-4-chloro-2-phenylpyridazin-3(2H)-one; plant growth regulators such as 2-chloroethyl trimethylammonium; dicarboximide herbicides such as ethyl (Z)-2-chloro-3-[2-chloro-5-(cyclohex-1-ene-1,2-dicarboximido)phenyl]acrylate; herbicides such as (1RS,2SR, 4SR)-1,4-epoxy-p-menth-2-yl 2-methylbenzyl ether; bird repellents and copper fungicides such as dicopper chloride trihydroxide; chlorotriazine herbicides such as 2-(4-chloro-6-ethylamino-1,3,5-triazin-2-ylamino)-2-methylpropionitrile; pyrimidinylsulfonylurea herbicides such as 1-[2-(cyclopropylcarbonyl)anilinosulfonyl]-3-(4,6-dimethoxypyrimidin-2-yl)urea; cyclohexene oxime herbicides such as (RS)-(EZ)-2-[1-(ethoxyimino)butyl]-3-hydroxy-5-thian-3-ylcyclohex-2-en-1-one; cyclic dithiocarbamate fungicides, dithiocarbamate herbicides and nematicides such as 3,5-dimethyl-1,3,5-thiadiazinane-2-thione, tetrahydro-3,5-dimethyl-1,3,5-thiadiazine-2-thione; benzoic acid herbicides and plant growth regulators such as 3,6-dichloro-o-anisic acid; phenoxypropionic herbicides and plant growth regulators such as (RS)-2-(2,4-dichlorophenoxy)propionic acid; quaternary ammonium herbicides such as 1,2-dimethyl-3,5-diphenylpyrazolium; urea herbicides such as 2-{1-[4-(3,5-difluoro phenyl)semicarbazono]ethyl}nicotinic acid; amide herbicides such as (S)-2-chloro-N-(2,4-dimethyl-3-thienyl)-N-(2-methoxy-1-methylethyl)acetamide; organothiophosphate acaricides, aliphatic amide organothiophosphate insecticides and nematicides such as O,O-dimethyl S-methylcarbamoylmethyl phosphoro dithioate, 2-dimethoxyphosphinothioylthio-N-methylacetamide; morpholine fungicides such as (EZ)-4-[3-(4-chlorophenyl)-3-(3,4-dimethoxyphenyl)acryloyl]morpholine; strobilurin fungicides such as (E)-2-(methoxyimino)-N-methyl-2-[α-(2,5-xylyloxy)-o-tolyl]acetamide; quinone fungicides such as 5,10-dihydro-5,10-dioxonaphtho[2,3-b]-1,4-dithi-in-2,3-dicarbonitrile; morpholine fungicides such as 4-cyclododecyl-2,6-dimethylmorpholine; conazole fungicides such as (2RS,3SR)-1-[3-(2-chlorophenyl)-2,3-epoxy-2-(4-fluorophenyl)propyl]-1H-1,2,4-triazole; pyrazole insecticides such as 5-amino-1-(2,6-dichloro-α,α,α-trifluoro-p-tolyl)-4-ethylsulfinylpyrazole-3-carbonitrile; organotin acaricides such as bis[tris(2-methyl-2-phenylpropyl)tin]oxide; amide fungicides such as a mixture of 85% (R)—N—[(RS)-1-cyano-1,2-dimethylpropyl]-2-(2,4-dichlorophenoxy)propionamide and 15% (S)—N—[(RS)-1-cyano-1,2-dimethylpropyl]-2-(2,4-dichlorophenoxy)propionamide; morpholine fungicides such as (RS)-cis-4-[3-(4-tert-butylphenyl)-2-methylpropyl]-2,6-dimethylmorpholine; pyrazole acaricides and insecticides such as 5-amino-1-(2,6-dichloro-α,α,α-trifluoro-p-tolyl)-4-trifluoromethylsulfinylpyrazole-3-carbonitrile; arylalanine herbicides such as N-benzoyl-N-(3-chloro-4-fluorophenyl)-D-alanine; coumarin rodenticides such as 4-hydroxy-3-[1,2,3,4-tetrahydro-3-[4-(4-trifluoromethylbenzyloxy)phenyl]-1-naphthyl]coumarin (e.g. mixture of cis- to trans-isomers in the ratio range 60:40 to 40:60); pyrethroid ester acaricides and insecticides such as (RS)-α-cyano-3-phenoxybenzyl(S)-2-(4-difluoromethoxyphenyl)-3-methylbutyrate; mite growth regulators and insecticides such as 1-[4-(2-chloro-α,α,α-trifluoro-p-tolyloxy)-2-fluorophenyl]-3-(2,6-difluorobenzoyl)urea; nitrophenyl ether herbicides such as O-[5-(2-chloro-α,α,α-trifluoro-p-tolyloxy)-2-nitrobenzoyl]glycolic acid; organophosphorus herbicides such as N-(phosphonomethyl)glycine; insecticides moulting hormone agonists such as N-tert-butyl-N′—(4-chlorobenzoyl)benzohydrazide; mite growth regulators and acaricides such as (4RS,5RS)-5-(4-chlorophenyl)-N-cyclohexyl-4-methyl-2-oxo-1,3-thiazolidine-3-carboxamide; insecticides such as 5,5-dimethylperhydropyrimidin-2-one 4-trifluoromethyl-α-(4-trifluoromethylstyryl)-cinnamylidenehydrazone; imidazolinone herbicides such as a reaction mixture of (RS)-6-(4-isopropyl-4-methyl-5-oxo-2-imidazolin-2-yl)-m-toluic acid and (RS)-2-(4-isopropyl-4-methyl-5-oxo-2-imidazolin-2-yl)-p-toluic acid; imidazolinone herbicides such as (RS)-2-(4-isopropyl-4-methyl-5-oxo-2-imidazolin-2-yl)-5-methoxymethylnicotinic acid, (RS)-2-(4-isopropyl-4-methyl-5-oxo-2-imidazolin-2-yl)-5-methylnicotinic acid, (RS)-2-(4-isopropyl-4-methyl-5-oxo-2-imidazolin-2-yl)nicotinic acid, (RS)-2-(4-isopropyl-4-methyl-5-oxo-2-imidazolin-2-yl)quinoline-3-carboxylic acid, (RS)-5-ethyl-2-(4-isopropyl-4-methyl-5-oxo-2-imidazolin-2-yl)nicotinic acid; dichlorophenyl dicarboximide fungicides and imidazole fungicides such as 3-(3,5-dichlorophenyl)-N-isopropyl-2,4-dioxoimidazolidine-1-carboxamide; strobilurin fungicides such as methyl(E)-methoxyimino[α-(o-tolyloxy)-o-tolyl]acetate; growth inhibitors such as 1,1-dimethylpiperidinium; insecticides such as (EZ)-2′-[2-(4-cyanophenyl)-1-(α,α,α-trifluoro-m-tolyl)ethylidene]-4-(trifluoromethoxy)carbanilohydrazide; dithiocarbamate fungicides, herbicides and nematicides such as methyldithiocarbamic acid; chloroacetanilide herbicides; conazole fungicides such as (1RS,5RS; 1RS,5SR)-5-(4-chlorobenzyl)-2,2-dimethyl-1-(1H-1,2,4-triazol-1-ylmethyl)cyclopentanol; zinc ammoniate ethylenebis(dithiocarbamate)-poly(ethylenethiuramdisulfide); phenylurea herbicides such as 3-(4-bromophenyl)-1-methoxy-1-methylurea; phenylurea herbicides and plant growth regulators such as 3-(3-chloro-4-methoxyphenyl)-1,1-dimethylurea; fungicides such as 3′-bromo-2,3,4,6′-tetramethoxy-2′,6-dimethylbenzophenone; fungicides such as di-isopropyl 5-nitroisophthalate; strobilurin fungicides such as (2E)-2-(methoxyimino)-2-{2-[(3E,5E,6E)-5-(methoxyimino)-4,6-dimethyl-2,8-dioxa-3,7-diazanona-3,6-dien-1-yl]phenyl}-N-methylacetamide; dinitroaniline herbicides such as N-(1-ethylpropyl)-2,6-dinitro-3,4-xylidine; organothiophosphate acaricides, aliphatic amide organothio phosphate insecticides and nematicides such as O,O-diethyl S-ethylthio methyl phosphorodithioate; anilide herbicides and pyridine herbicides such as 4′-fluoro-6-(α,α,α-trifluoro-m-tolyloxy)pyridine-2-carboxanilide; amide fungicides and conazole fungicides such as N-propyl-N-[2-(2,4,6-trichloro phenoxy)ethyl]imidazole-1-carboxamide, 1-{N-propyl-N-[2-(2,4,6-trichlorophenoxy)ethyl]}carbamoylimidazole; cyclohexene oxime herbicides such as 2-{(EZ)-1-[(2RS)-2-(4-chlorophenoxy)propoxyimino]butyl}-3-hydroxy-5-(thian-3-yl)cyclohex-2-en-1-one; plant growth regulators such as 3,5-dioxo-4-propionylcyclohexanecarboxylic acid; strobilurin fungicides such as methyl N-{2-[1-(4-chlorophenyl)-1H-pyrazol-3-yloxymethyl]phenyl}(N-methoxy)carbamate; acaricides and insecticides such as 2-tert-butyl-5-(4-tert-butylbenzylthio)-4-chloropyridazin-3(2H)-one; pyrimidine fungicides such as N-(4,6-dimethylpyrimidin-2-yl)aniline; quinolinecarboxylic acid herbicides such as 3,7-dichloroquinoline-8-carboxylic acid, 7-chloro-3-methylquinoline-8-carboxylic acid; cyclohexene oxime herbicides such as (RS)-(EZ)-2-(1-ethoxy iminobutyl)-5-[2-(ethylthio)propyl]-3-hydroxycyclohex-2-en-1-one, pyrazole acaricides and insecticides such as N-(4-tert-butylbenzyl)-4-chloro-3-ethyl-1-methylpyrazole-5-carboxamide; insecticides and chitin synthesis inhibitors such as 1-(3,5-dichloro-2,4-difluorophenyl)-3-(2,6-difluorobenzoyl)urea; phenyl organothiophosphate insecticides such as O,O,O′,O′-tetramethyl O,O′-thiodi-p-phenylene bis(phosphorothioate), O,O,O′,O′-tetramethyl O,O′-thiodi-p-phenylene diphosphorothioate; cyclohexene oxime herbicides such as (RS)-(EZ)-2-{1-[(2E)-3-chloroallyloxyimino]propyl}-3-hydroxy-5-perhydropyran-4-ylcyclohex-2-en-1-one; aliphatic organothiophosphate insecticides and nematicides such as S-tert-butylthiomethyl O,O-diethyl phosphoro dithioate; benzimidazole precursor fungicides and carbamate fungicides such as dimethyl 4,4′-(o-phenylene)bis(3-thioallophanate); phenyl pyrazolyl ketone herbicides such as [3-(4,5-dihydro-1,2-oxazol-3-yl)-4-mesyl-o-tolyl](5-hydroxy-1-methyl-1H-pyrazol-4-yl)methanone; insecticides such as ethyl (3-tert-butyl-1-dimethylcarbamoyl-1H-1,2,4-triazol-5-ylthio)acetate; morpholine fungicides such as a reaction mixture of 4-alkyl-2,6-dimethylmorpholines, where “alkyl” is mixture of C11-C14 homologues of which 60-70% is tridecyl; amide fungicides such as N,N′-{piperazine-1,4-diylbis[(trichloromethyl) methylene]}diformamide, 1,1′-piperazine-1,4-diyldi-[N-(2,2,2-trichloroethyl)formamide]; conazole fungicides such as (RS)-(E)-5-(4-chlorobenzylidene)-2,2-dimethyl-1-(1H-1,2,4-triazol-1-ylmethyl)cyclopentanol; triazinylsulfonylurea herbicides such as 1-[4-methoxy-6-(trifluoromethyl)-1,3,5-triazin-2-yl]-3-[2-trifluoromethyl)benzenesulfonyl]urea; dichlorophenyl dicarboximide fungicides; oxazole fungicides such as (RS)-3-(3,5-dichlorophenyl)-5-methyl-5-vinyl-1,3-oxazolidine-2,4-dione.

Pesticides can undergo environmental transformation. This includes biological transformation such as metabolization (aerobic or anaerobic) and chemical (including photochemical) transformation, e.g. chemical reactions such as hydrolysis, oxidation and isomerization. For the purposes of this invention, transformation means conversion to other organic compounds. Thus, transformation products of pesticides include in particular metabolization products (metabolites) as well as reaction products of the pesticide, metabolites and reaction products being of particular importance to the method of the present invention.

Physicochemical properties such as solubility, partition coefficient and stability data, as well as information regarding the environmental fate (half-life, DT₅₀, metabolites) can be taken from standard handbooks such The Pesticide Manual, British Crop Protection Council, e.g. the 12^{th} edition 2000.

The sample can be any sample derived from the soil or plant material that is at risk of containing pesticidal residues.

Residual amounts of pesticidal compounds usually mean trace amounts of pesticidal compounds. Accordingly, the sample usually comprises less than 1% by weight, less than 0.5%, or less than 0.1% by weight, in particular less than 500 ppm by weight, or less than 100 ppm by weight, and especially less than 50 ppm by weight, less than 10 ppm by weight, less than 1 ppm by weight, less than 0.1 ppm by weight, or less than 0.01 ppm by weight of one or more than one pesticidal compound. The method of the present invention can be used to determine trace amounts of 0.00001 ppm by weight or more, in particular more than 0.0001 ppm by weight, and especially more than 0.001 ppm by weight of one or more than one pesticidal compound. Thus, the method of the present invention in particular relates to the analysis of samples which are at risk of comprising 0.00001 to 1% by weight, in particular 0.0001 to 500 ppm by weight, and especially 0.001 ppm to 50 ppm of one or more than one pesticidal compound.

According to a particular embodiment of the present invention, the sample is soil. As used herein, soil means a mixture of mineral and organic material that plants grow in. Soil can thus be referred to as a medium for plant growth. Soil may also be regarded as providing an environment for the breakdown and immobilization of materials added to the surface, such as pesticides.

In the method of the present invention, any type of soil can be used. These include sand, silt, clay, loam and mixtures thereof. Sandy loam, clay loam, sandy clay loam, loam are of particular importance. Also, soil with high organic matter, in particular soil having a proportion of organic matter of more than 10% by weight and especially of more than 20% by weight are of importance according to the invention. Usually, the proportion of organic matter in said soil is less than 40% by weight, in particular less than 30% by weight. A typical example of soil with high organic matter is one having a proportion of organic matter in the range of 20 to 30% by weight.

According to a further particular embodiment of the present invention, the sample is plant material. As used herein, plant material refers to plants in any stage of maturity or development (including seeds), as well as any tissue or organs (plant parts) taken or derived from any such plant. Plant parts include, but are not limited to, stems, roots, flowers, ovules, stamens, leaves, embryos, meristematic regions, callus tissue, anther cultures, gametophytes, sporophytes, pollen, microspores, protoplasts, and the like as well as processed products such as fodder, forage, hay, flour, nutmeat and the like. Accordingly, particular examples of environmental samples include alfalfa, e.g. alfalfa hay, almond, e.g. almond hull, almond nutmeat, apple, e.g. apple pomace, asparagus, avocado, banana, brassica, basil, e.g. dried basil, canola seed, carrot, celery, cherry, citrus oil, coffee bean, corn, e.g. corn grain, corn fodder, corn forage, corn stover, cotton, e.g. cottonseed, cotton gin byproduct, cotton gin waste, cucumber, grape, grass, e.g. grass hay, grass forage, honey, hop, e.g. dry hop, fresh hop, lettuce, fresh mint, onion, e.g. dry bulb onion, green onion, orange, peach, peanut, e.g. peanut hay, peanut hull, peanut nutmeat, pea, e.g. dry pea seed, pear, pecan, potato, e.g. dehydrated potato, potato peel, poultry feed, prune, raisin, rice, e.g. brown rice, rice straw, sorghum, e.g. sorghum grain, sorghum hay, soybean, e.g. soybean hay, spinach, strawberry, sugarbeet foliage, sugarbeet, e.g. sugarbeet root, sugarbeet top, sugarcane, summer squash, sunflower, e.g. sunflower oil, sunflower seed, starfruit, tomato, e.g. tomato paste, walnut nutmeat, and wheat, e.g. wheat flour, wheat grain, wheat forage, wheat hay, wheat straw.

Providing a soil sample usually involves several issues including sampling depth and sample quantity. Sampling depth depends on the type of soil used. In cultivated soils, samples are usually taken from the topsoil, i.e. at a depth of 20 to 30 cm for arable soils and at a depth of 10 cm or less for pasture soils. In uncultivated soils, samples are usually taken at a soil depth of 10 cm or less. The sample quantity per sampling point is determined by the condition of the soil material. In view of the heterogeneity of soil, a minimum quantity is usually required to provide a representative sample. Moreover, more than one sampling point is usually required to statistically represent the residue situation found in the field. Therefore, the sample quantity is usually at least 500 g, in particular at least 750 g, and especially at least 1000 g, at least 1250 g, at least 1500 g, at least 1750 g, at least 2000 g, at least 2250 g, or at least 2500 g, the quantity in question being obtained from either a single or 2 or more sampling points. On the other hand, the sample quantity should allow a convenient processing of the sample. Therefore, the sample quantity is usually not more than 25,000 g, preferably not more than 20,000 g and in particular not more than 10,000 g. This sample quantity is hereinafter also referred to as the bulk sample. The amounts specified above refer to a soil sample as it is taken, i.e. a sample that in particular has not been subjected to special drying. Accordingly, the water content of the soil sample essentially corresponds to the water content of the natural soil from which the sample has been taken.

Similar sample quantities apply to plant material. Therefore, the sample quantity is usually at least 300 g, in particular at least 400 g, and especially at least 500 g, at least 1000 g, at least 1500 g, at least 2000 g, at least 3000 g, at least 4000 g, or at least 5000 g, the quantity in question being obtained from either a single or 2 or more sampling points. On the other hand, the sample quantity should allow a convenient processing of the sample. Therefore, the sample quantity is usually not more than 5000 g, in particular not more than 2000 g and especially not more than 1000 g. This sample quantity is hereinafter also referred to as the bulk sample. The amounts specified above refer to a plant sample as it is taken (raw agricultural commodity), i.e. a sample that in particular that has not been subjected to special drying. Accordingly, the water content of the plant sample essentially corresponds to the water content of the natural plant material from which the sample has been taken.

Processing the sample to a fine powder usually requires subjecting the sample to size reduction. Size reduction, also known as comminution, is defined as the breakdown of matrices, in particular solids, into smaller particles. Expediently, size reduction is carried out mechanically.

There are alternative ways to describe the fine powder in terms of particle size. According to the present invention, the term particle size is used for particle sizes determined by sieve analysis, e.g. using conventional sieves and sieve shakers such as W. S. Tyler sieve shaker. According to the present invention, the term volume-weighted particle size (synonymous: volume-weighted mean particle size) is used for particle sizes determined by optical measurements such as light scattering techniques and in particular laser diffraction, e.g. using conventional laser particle sizing instruments such as Malvern Mastersizer 2000.

As the sample is considered to usually represent a multi-component material, one objective of size reduction in accordance with the present invention is to homogenize the sample. A further objective of size reduction according to the present invention is the production of a desired particle size. In case the particle size is determined by sieve analysis (by shaking appropriate sieves for sufficient time to allow separation of those particle which pass the sieve and those which are retained, e.g. 30 minutes at 300 rpm), a powder having a particle size of 800 μm or less, in particular 700 μm or less, and especially 600 μm or less, 550 μm or less, 500 μm or less, 450 μm or less, or 400 μm or less, is considered to be a fine powder and expedient for the purposes of the invention.

According to another aspect, at least 80%, in particular at least 85%, and especially at least 90%, at least 91%, at least 92%, at least 93%, at least 94%, at least 95%, at least 96%, at least 97%, at least 98%, or at least 99% of all particles of said powder have a particle size of less than 600 μm.

According to a particular aspect, at least 80%, in particular at least 85%, and especially at least 90%, at least 91%, at least 92%, at least 93%, at least 94%, at least 95%, at least 96%, at least 97%, at least 98%, or at least 99% of all particles of said powder have a particle size of less than 500 μm.

According to a special aspect, at least 80%, in particular at least 85%, and especially at least 90%, at least 91%, at least 92%, at least 93%, at least 94%, at least 95%, at least 96%, at least 97%, at least 98%, or at least 99% of all particles of said powder have a particle size of less than 400 μm.

In case the particle size is determined by laser diffraction (by measuring the scattering of laser light by the powder in dry state in accordance with ISO 13320-1 (Nov. 1, 1999), e.g. by using Malvern Mastersizer 2000: measuring time 20 seconds, 95% vibration feed rate and a Dispersive Air Pressure of 4), a powder having a volume-weighted particle size of 700 μm or less, preferably 600 μm or less, and in particular 500 μm or less, 450 μm or less, or 400 μm or less, is considered to be a fine powder and expedient for the purposes of the invention.

According to another aspect, at least 80%, in particular at least 85%, and especially at least 90%, at least 91%, at least 92%, at least 93%, at least 94%, at least 95%, at least 96%, at least 97%, at least 98%, or at least 99% of all particles of said powder have a volume-weighted particle size of less than 500 μm.

According to a particular aspect, at least 80%, in particular at least 85%, and especially at least 90%, at least 91%, at least 92%, at least 93%, at least 94%, at least 95%, at least 96%, at least 97%, at least 98%, or at least 99% of all particles of said powder have a volume-weighted particle size of less than 400 μm.

According to a special aspect, at least 80%, in particular at least 85%, and especially at least 90%, at least 91%, at least 92%, at least 93%, at least 94%, at least 95%, at least 96%, at least 97%, at least 98%, or at least 99% of all particles of said powder have a volume-weighted particle size of less than 300 μm.

Preferably, size reduction is carried out stepwise. This has the advantage that the means for size reduction can be selected more appropriately, depending on the particle size and consistency of the starting material and the particle size to be achieved. Accordingly, it is preferable to obtain an intermediate material which results from at least one size reduction step and which is subjected to at least one further size reduction step. In accordance with the method of the present invention, said intermediate material is referred to as particulate material. In practice, said particulate material can be processed further directly after it is obtained, or stored for processing later on. If stored, this is preferably done at reduced temperature, e.g. below 0° C.

According to a particular embodiment of the present invention, size reduction comprises a first step of homogenizing the sample. One objective of this step is to convert the bulk sample to a particulate material that can be conveniently processed to a powder having the desired particle size.

This step of homogenizing the environmental sample is well known to those skilled in the art. Homogenizing may comprise mixing, cutting, grinding and/or sieving in any order, depending on the environmental sample.

According to a particular embodiment of the present invention, soil is converted to a particulate material having a particle size of less than about 5 mm, in particular less than about 3 mm and especially less than about 2 mm, less than about 1.5 or less than about 1 mm. Due to the type of size reduction carried out in this first step, the particle size will usually be above about 0.5 mm, in particular above about 0.75 mm and especially above about 1 mm, above about 1.25 or above about 1.5 mm. Plant material is converted to a particulate material having a particle size of less than about 5 mm, in particular less than about 2.5 mm and, especially, less than about 2 mm, less than about 1.5 mm or less than about 1 mm. Due to the type of size reduction carried out in this first step, the particle size will usually be above about 0.8 mm, in particular above 1.0 mm and especially above about 1.5 mm, above about 2.0 or above 3.0 mm.

Said conversion can be carried out manually or using suitable devices such as mixers, cutters, grinders and/or sieves. For soil samples, homoloid mills such as FitzMILL®, e.g. model J and JT, have proven especially suitable. For plant material, cutting and mixing devices such as the Urschel Comitrol model 2600 food cutter, Stephan model 40 vertical cutter/mixer or Hobart HCM 450 vertical cutter/mixer have proven especially suitable.

According to a further particular embodiment of the present invention, size reduction comprises a second step of milling the particulate material resulting from the first step to yield the fine powder. This milling step can be performed using any device known in the art to produce the desired particle size. According to a preferred embodiment, milling is ultracentrifugal milling and planetary milling. Advantageously, the milling step further comprises sieving the milled material so as to provide a powder having the desired particle size. Milling and sieving can be conveniently combined in one and the same device. For instance, the Retsch® ZM 100 ultracentrifugal mill has proven especially suitable. Other suitable mills include, for instance, mortar grinder LC-102 (Gilson company), SPEX CertiPre 8000M Mixer/Mill (from SPEX CertiPre company), and planetary ball mills made by Retsch (supplied by GlenMills) and Fritsch (supplied by Gilson).

Preferably, only a portion of the particulate material obtained in the first step is subjected to the milling step (second step). Accordingly, the particulate material is divided into at least two portions. The resulting portions can be essentially of the same size (volume or weight) or not. According to the present invention, it is preferable that a portion having a weight of at least 10 g, in particular at least 25 g and especially at least 50 g, at least 60 g, at least 70 g, at least 80 g, at least 90 g, or at least 100 g, be taken from the particulate material and processed to the powder. On the other hand, the portion should allow a convenient processing of the particulate material. Therefore, said portion usually has a weight of not more than 200 g, in particular not more than 150 g, and especially not more than 100 g. This portion is hereinafter also referred to as the sub-sample.

Dividing the particulate material into at least two portions can be carried out manually or mechanically. Assuming the particulate material is sufficiently homogenous, portions can be obtained by random sampling. For instance, portions may be obtained by “spooning” and other techniques, which involve the random insertion of a spoon or other sampling device into the particulate material. Alternatively, the classic cone-and-quarter technique or so-called splitters such as ruffle splitters, rotary splitters or multiple-cone splitters can be used. In accordance with the cone-and-quarter technique, the particulate material is poured into a cone, the cone is flattened, the flattened cone is divided into four equal parts (quartering) and then two opposite quarters are removed. The remaining two quarters are repiled into a cone and the process is repeated until the desired sample size is obtained.

The samples may contain liquid, in particular water, and thus their consistency may be considered as being rather semi-solid than solid. In order to conveniently process such samples to the powder, it is expedient to increase the consistency of the samples, e.g. solidify the samples.

Thus, according to a preferred embodiment, size reduction is carried out at reduced temperature. Temperatures below 0° C. and preferably below −20° C. are suitable. Reduced temperatures may allow for a more efficient size reduction in case the sample or the particulate material is rather semi-solid than solid and/or minimize the decomposition of the analytes of interest. Reduced temperatures may be conveniently obtained by using dry ice and/or liquid nitrogen.

The fine powder having the desired particle size is then converted into a form accessible for determining the analyte.

Preferably, only a portion of the powder obtained by size reduction is subjected to said conversion. Accordingly, the powder is divided into at least two portions. The resulting portions can be essentially of the same size (volume or weight) or not. According to the present invention, it is preferable to take and convert a portion of the powder having a weight of less than 5 g, in particular less than 1 g and especially less than 0.9 g, less than 0.8 g, less than 0.7 g, less than 0.6 g, less than 0.5 g, less than 0.4 g, less than 0.3 g, less than 0.2 g, or less than 0.1 g. On the other hand, the portion should allow the determination of the analyte. Therefore, said portion usually has a weight of at least 0.01 g, in particular at least 0.05 g, and especially at least 0.1 g. This portion is hereinafter also referred to as the powder portion or aliquot.

For statistical reasons, it may be expedient to take at least 2, preferably at least 3 and in particular at least 5 powder aliquots.

According to a particularly preferred embodiment of the present invention, at least two powder aliquots are then converted in parallel into a form accessible for determining the analyte. Said powder aliquots may be derived from the same bulk sample or from different bulk samples.

It is a particular advantage of the method of the present invention that the powder portion and in particular each powder aliquot can have a relatively small weight, preferably in the range of 0.001 g to 5 g, more preferably in the range of 0.01 to 1 g and in particular in the range of 0.05 to 0.5 g. This allows miniaturization and thus the use of techniques based on bioanalytical methods.

One objective of converting the powder into a form accessible for determining the pesticidal analyte is to separate the analyte to be determined from further powder constituents and/or to render low analyte concentrations determinable by concentration steps. In this regard, wet chemical methods have the advantage of enabling the use of various measuring systems as well as simple calibration by known standards.

Thus, the step of converting the powder into a form accessible for determining the pesticidal analyte preferably comprises separating analyte from non-analyte thereby providing the analyte in a form accessible for determining the analyte. Said form provided may contain the analyte in a higher concentration than the powder or may enable its enrichment by further separating analyte from non-analyte. For instance, if said form is a solution containing the analyte, removing solvent enables the enrichment of the analyte.

Techniques for converting a powder into a form accessible for determining a powder constituent (the analyte) are well known to those skilled in the art. Suitable techniques comprise, in particular, extraction, elution and/or digestion of the powder.

According to a particular embodiment of the present invention, converting the powder into a form accessible for determining the analyte comprises providing a solution containing the analyte. Accordingly, the powder is treated with a solvent or a mixture of solvents capable of dissolving the analyte. Treatment with solvent or solvent mixture can comprise treatment with a sequence of different solvents or solvent mixtures, as appropriate. If more than one solvent or solvent mixture is used in sequence, it may be expedient to combine the solutions obtained.

Preferably, the powder is treated with solvent or solvent mixture in order to extract (extraction, optionally multistep extraction) or to elute the analyte. Extraction, optionally multistep extraction, is usually particularly preferred.

The solvent or the solvent mixture to be used for extracting or eluting the analyte depends on both the pesticidal analyte and the remaining powder constituents. Based on common general knowledge, the skilled person is in a position to select a solvent or a solvent mixture that allows the separation of the pesticidal analyte of the remaining powder constituents so as to provide a solution of the analyte that is accessible for determining the analyte. Separation as used here means an enrichment of the analyte compared to the remaining constituents. In many cases, alcohols such as methanol or ethanol, ethers such as diethylether, dioxane or tetrahydrofurane, ketones such as acetone or cyclohexanone, hydrocarbons such as toluene, xylene, hexane, pentane or cyclohexane, halogenated solvents such as dichloromethane, other polar solvents such as acetonitrile, dimethyl formamide (DMF) and dimethyl sulphoxide (DMSO), mixtures thereof, or mixtures of said solvent(s) with water allow the provision of the pesticidal analyte in the form of a suitable solution.

It is a particular advantage of the method of the present invention that the amount of solvent used can be rather small. The use of small amounts of solvent is made possible by the small powder portions or aliquots, as described above. Preferably, less than 500 mL, less than 100 mL, less than 50 mL, less than 25 mL, less than 10 mL, less than 5 mL, less than 2.5 mL, less than 2 mL, less than 1 mL or less than 0.5 mL solvent or solvent mixture are used for converting the powder portion or aliquot. In case of a multistep conversion, e.g. the use of more than one solvent or solvent mixture in sequence, it is preferred to use said amounts for each conversion. Said small volumes such as 10 mL or less, preferably 5 mL or less and in particular 0.5 mL or less, conveniently allow the conversion of more than 1 powder portion or aliquot in parallel. In particular 2 to 24, 2 to 96 or even multiples thereof can be converted in parallel. For instance, 24 well- or even 96 well-microtiter plates can be used conveniently as recipients for carrying out each conversion, e.g. extraction.

The treatment of the powder portion or aliquot in order to extract the analyte usually comprises agitating the powder solvent mixture. Agitating can involve, for instance, shaking or sonicating or vortexing the sample. Usually, the treatment is performed at ambient temperature, i.e. in the range of 20 to 30° C. Lower or higher temperatures ranging from the melting to the boiling point of the solvent or solvent mixture used may, however, be expedient. Nonetheless, temperatures of 50° C. or higher are usually not required according to the present invention and thus can usually be avoided.

Further, it is preferred that the treatment is carried out under atmospheric or near atmospheric pressure (about 10⁵ Pa, or in the range of 12 to 20 psi). This includes an increase of pressure that may occur if the treatment is carried out in a sealed vessel and the temperature raises.

Also, it may be expedient to separate the solution from the remaining powder constituents, e.g. by centrifugation, so that the solution or a portion thereof is readily accessible and can be subjected to the subsequent steps.

Determining the analyte usually comprises detecting the analyte. To this end, the form accessible for determining the analyte, e.g. the solution or a portion thereof optionally containing the analyte, is subjected to said determination.

Suitable means for detecting pesticidal analytes are well known to those skilled in the art. Many substance- and structure-specific detectors are suitable. Examples are flame-ionization detectors (FID), thermionic detectors (TID), electron-capture detectors (ECD), UVNIS detectors or diffraction detectors. Mass spectrometry is particularly suitable.

In the method of the present invention, determining preferably comprises (further) separating the analyte prior to its detection. Such a separation can conveniently be performed by chromatography, preferably gas chromatography (GC) or liquid chromatography (LC) such as high-performance liquid chromatography (HPLC).

Moreover, the skilled person will appreciate that (further) separation and detection may be coupled. In particular, the coupling of gas or liquid chromatography with mass spectrometry (GC-MS or LC-MS) is usually suitable for determining the pesticidal analyte.

The determination in accordance with the method of the present invention can provide a qualitative or quantitative result. It may further include calibration, for instance by using standard reference materials containing no pesticidal analyte (negative control) or known concentrations of the pesticidal analyte (positive control).

Technical guidance on how to detect a pesticidal analyte can also be found in standard handbooks such The Pesticide Manual, British Crop Protection Council, e.g. the 12^{th} edition 2000.

The following non-limiting examples further illustrate the present invention.

### EXAMPLE 1

### Determination of Residual BAS 320 I, and It's Metabolites in Soil Matrices

Residues of BAS 320 I (E- and Z-isomers) and its metabolites, p-[m-(trifluoromethyl)-phenacyl]benzonitrile (M320104), p-cyanobenzoic acid (M320106) and 4-[5-hydroxy-3-oxo-4-{4-(trifluoromethoxy)phenyl}-6-{3-(trifluoromethyl)phenyl}-2,3,4,5-tetrahydro-1,2,4-triazin-5-yl]benzonitrile (M320123) in soil have been measured.

Soil samples were processed to a fine powder by a stepwise reduction in size. First, the bulk samples (about 2 to 5 kg) were homogenized using a homoloid mill (FitzMILL®). During the homogenization step the sample was cooled with dry ice. An aliquot (about 100 g) was removed from the resulting particulate material and further milled in a Retsch® ZM 100 ultracentrifugal mill equipped with a 1.0 mm screen. During the milling step the sample was cooled with liquid nitrogen. The resulting fine powder was stored frozen in plastic bags until the time of analysis.

Soil powder samples were weighed (100±5 mg) into a 1.4 mL Matrix AlphaNumeric well plate tube (e.g. 96 or other comparable well plate vessel). An exact weight of 100 mg for the treated samples was not necessary as the exact weight was included in the calculations. For procedural recovery samples, an appropriate amount of fortification solution (100 pg/μL standard solution) was added to achieve the desired fortification (0.1 and 0.01 ppm for each sample analysis set). Using an automated liquid handling system (e.g. Quadra96®, Model 320 or other comparable instrument), an extraction solvent (methanol, 0.4 mL) was added to each sample.

The tubes were capped firmly with the Matrix SepraSeal caps (or other appropriate cap). Samples were vortexed upside down on a Multitube Vortexer at maximum speed (2400 rpm) for one minute or were placed on a mechanical shaker to shake for 5 minutes at 300 rpm. A vortex cycle at maximum speed for 1.0 minute right side up was performed afterwards.

Using the automated liquid handling system, an aliquot of another extraction solvent (methanol-water, 1:1, v/v, 0.4 mL) was added to each sample. The tubes were re-capped firmly with the Matrix SepraSeal caps (or other appropriate cap). Samples were vortexed upside down on a Multitube Vortexer at maximum speed (2400 rpm) for one minute or were placed on a mechanical shaker to shake for 5 minutes at 300 rpm. A vortex cycle at maximum speed for 1.0 minute right side up was performed afterwards. The samples were then centrifuged for 5 minutes at 2500 rpm in a swinging bucket centrifuge.

Aliquots (0.5 mL) of the resulting extract were removed from supernatant of the tube containing the extracted samples and transferred into another 96 well plate using a Quadra96®, Model 320, for the LC-MS/MS analysis.

The LC-MS/MS analyses were performed on PE Sciex API 4000 Biomolecular Mass Analyzer. For quantitation, the transitions monitored are 505.1-301.9 for BAS 320 I (E- and Z-isomers), and 288.1-141.8, 146.0-101.9, and 519.2-184.8 for M320104, M320106 and M320123, respectively.

Good recoveries of BAS 320 I (E- and Z-isomers) and its metabolites, were obtained in various soil types over the entire fortification range tested (0.01 ppm to 0.1 ppm). For example, the overall recoveries in sandy loam soil were 107% (SD=1.9, N=16), 93% (SD=1.9, N=16) and 109% (SD=1.9, N=16) for BAS 320 I (E-isomer), BAS 320 I (Z-isomer) and M320123, respectively. The overall recoveries in clay loam soil were 71% (SD=4.9, N=6), 66% (SD=7.1, N=6) and 79% (SD=6.4, N=6) for BAS 320 I (E-isomer), BAS 320 I (Z-isomer) and M320123, respectively.

The method has a limit of quantitation of 0.01 mg/kg in soil for each analyte.

### EXAMPLE 2

### Determination of the particle size of the powder produced by size reduction.

A soil sample was processed to a powder as described in example 1.

The particle size produced by milling of the soil sample was determined by laser diffraction and sieve analysis.

For laser diffraction analysis the Malvern Mastersizer 2000 system was used. The Mastersizer calculates the size of particles by passing the particles through a laser beam, takes a snapshot of how the light is scattered, and back calculates the size of the particle that would produce the light scattering pattern. It is equipped with two lasers; a red laser produced by a Helium/Neon lamp with a maximum output of 5 mW and emits a beam with a 633 nm wavelength, and a blue laser produced by an light emitting diode. For each sample measurement, several thousand snapshots are taken to determine the particle size distribution.

The soil sample was run on the Mastersizer as a dry powder. The measurement time was 20 seconds (20000 snapshots) with a 95% vibration feed rate and the maximum Dispersive Air Pressure of 4. The results are summarized in the following table.

| Particle Size (μm) | %* |
|---|---|
| <399 | 99 |
| <158 | 84 |
| <80 | 60 |
| <32 | 30 |
| <6 | 10 |

*The instrument calculates the volume of the sample measured and determines the percentage of the sample by volume that is under given particle size.

For sieve analysis the W. S. Tyler sieve shaker with a Leeson motor was used. The sieve shaker was equipped with a 250 μm, 150 μm, 75 μm, 45 μm, and a <45 μm screen. The sample was shaken 30 minutes at 300 rpm and the particle size distribution was determined by weight. Approximately 70% of the particles are less than 250 μm. The size distribution observed from the sieve shaker is summarized in the table below. The total weight of the samples tested was 47.6 g.

| Screen Size (μm) | Particle Size Range (μm) | Weight (g) | % Total* |
|---|---|---|---|
| 250 | >250 | 14.91 | 31.2 |
| 150 | 250-150 | 8.84 | 18.6 |
| 75 | 150-75 | 11.4 | 24.0 |
| 45 | 75-45 | 9.47 | 19.9 |
| <45 | <45 | 2.98 | 6.3 |

| | | |
|---|---|---|
| Total Recovery | 47.6 | 100 |

*% Total Recovery based on sum of % total.

1-25. (canceled)

26. Method for determining a pesticidal analyte in soil, which comprises processing a soil sample to a powder having a particle size of 800 μm or less, treating the powder or a portion thereof with solvent capable of dissolving the analyte, thereby providing a solution that contains the analyte, and determining the analyte.

27. The method of claim 25, wherein the pesticidal analyte is a pesticide or a metabolite of a pesticide.

28. The method of claim 26, wherein the sample comprises less than 1% by weight of the pesticial analyte.

29. The method of claim 26, wherein the sample is soil.

30. The method of claim 26, wherein the sample has a weight in the range of 500 to 25,000 g.

31. The method of claim 26, wherein the processing of the sample comprises subjecting the sample to size reduction.

32. The method of claim 31, wherein size reduction comprises a first step of homogenizing the sample to yield a particulate material and a second step of milling the particulate material to yield the powder.

33. The method of claim 32, wherein the particulate material has a particle size of 1 to 5 mm.

34. The method of claim 32, wherein milling is ultracentrifugal milling.

35. The method of claim 32, wherein homogenizing and milling are performed at reduced temperature.

36. The method of claim 26, wherein the particle size is determined by sieve analysis.

37. The method of claim 26, wherein the powder has a particle size of 700 μm or less, or of 600 μm or less.

38. The method of claim 26, wherein the powder has a volume weighted particle size of 700 μm or less, of 600 μm or less, or of 500 μm or less.

39. The method of claim 26, wherein a portion of the powder is treated with solvent, the portion having a weight of less than 1 g.

40. The method of claim 39, wherein at least two portions are treated in parallel.

41. The method of claim 26, wherein treating the powder with solvent comprises extracting the analyte by means of a solvent or solvent mixture

42. The method of claim 41, wherein the analyte is extracted by means of a sequence of solvents or solvent mixtures.

43. The method of claim 42, wherein the amount of solvent or solvent mixture used is less than 1 mL for each extraction.

44. The method of claim 26, wherein determining the analyte comprises detecting the analyte.

45. The method of claim 44, wherein detecting the analyte is realized by mass spectrometry.

46. Method for determining a pesticidal analyte in plant material, which comprises processing a plant material sample to a powder having a particle size of 800 μm or less, treating the powder or a portion thereof with solvent capable of dissolving the analyte, thereby providing a solution that contains the analyte, and determining the analyte.

47. A method for determining a pesticidal analyte in soil or plant material, comprising processing by size reduction a soil or plant sample to a powder having a particle size no greater than 800 μm, treating at least a portion of the powder with a solvent capable of dissolving the analyte to provide a solution containing the analyte and determining the analyte present in the solution.
